(19) United States
(12) Patent Application Publication
(10) Pub. No.: US 2010/0098315 A1
(43) Pub. Date: Apr. 22, 2010

(54) ITERATIVE RECONSTRUCTION OF CORONARY ARTERIES

(75) Inventors: Eberhard Hansis, Hamburg (DE); Michael Grass, Buchholz In Der Nordheide (DE); Dirk Schafer, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/529,352

(22) PCT Filed: Feb. 27, 2008
(86) PCT No.: PCT/IB08/50695

§ 371 Date: Sep. 1, 2009

(30) Foreign Application Priority Data
Mar. 2, 2007 (EP) 07103423.5

(51) Int. Cl. G06K 9/62

(52) U.S. Cl. 382/132

(57) ABSTRACT

According to an exemplary embodiment of the present invention, an iterative reconstruction of coronary arteries comprises a filtering of projection data on the basis of a top-hat filter and an iterative reconstruction of the object of interest on the basis of a regularisation favouring sparse objects. This may provide for high contrast and detail.

The invention relates to the field of X-ray imaging. In particular, the invention relates to an examination apparatus for examination of an object of interest, a method of examination of an object of interest with an examination apparatus, an image processing device, a computer-readable medium and a program element.

Three-dimensional reconstruction of the coronary arteries may be performed from a rotational X-ray angiography projection sequence. For the reconstruction of one cardiac phase, only the projections from the sequence corresponding to that phase may be used. A severe undersampling resulting from the small number of projections (typically 5 to 10) may necessitate the use of special reconstruction algorithms.

One approach is to use an iterative reconstruction method with a suitable regularisation. A method for the reconstruction of a sparse, smooth object, of which the coronary artery tree is an example, is disclosed in [1, 2], which are hereby incorporated by reference herein. This method uses the minimization of the L1-norm of the image as regularisation, in conjunction with a Gibbs smoothing prior. However, the method may not work well on clinical data from a standard angiographic acquisition.

It would be desirable to have an improved reconstruction scheme for coronary angiography.

The invention provides an examination apparatus, an image processing device, a computer-readable medium, a program element and a method of examining an object of interest with the features according to the independent claims.

It should be noted that the following described exemplary embodiments of the invention apply also for the method of examination of the object of interest, for the computer-readable medium, for the image processing device and for the program element.

According to an aspect of the present invention, an examination apparatus for examination of an object of interest is provided, the examination apparatus comprising a calculation unit adapted for filtering projection data corresponding to projections of the object of interest, thus reducing the projection background (thereby retaining for example only the object of interest), and for performing an iterative reconstruction of the object of interest on the basis of a regularisation which favours sparse objects.

In other words, an examination apparatus is provided which is capable of reducing the background of the projections by applying a filter which removes structures larger than a certain size. This pre-processing step is followed by an iterative reconstruction step which favours sparse objects, such as, for example, vessel trees.

This may provide for an improved contrast for smaller vessels.

According to another exemplary embodiment of the present invention, the filtering of the projection data comprises an application of a top-hat filter, which removes structures larger than a predetermined size.

The application of such a top-hat filter may lead to an effective filtering during pre-procession of the data.

According to another exemplary embodiment of the present invention, the iterative reconstruction is based on a L1-minimizing iterative reconstruction as regularisation.

Such an L1-minimizing iterative reconstruction is based on the L1-norm, which is the sum of the norm of all elements of a vector. L1-minimization means in this context, that this sum is minimized, thus effectively favouring sparse objects.

According to another exemplary embodiment of the present invention, the iterative reconstruction is further based on a Gibbs smoothing prior as regularisation, thereby favouring smooth objects.

It should be noted, however, that other forms of regularisations may be implemented which favour smooth objects.

Furthermore, according to another exemplary embodiment of the present invention, the calculation unit is further adapted for calculating a three-dimensional vesselness prior representing a probability of a point in a reconstruction volume of the projection data to be occupied by a tubular structure.

Furthermore, the calculation of the three-dimensional vesselness prior may, according to another exemplary embodiment of the invention, be performed on the basis of an application of a two-dimensional vesselness filter to the projection images and then using a L1-minimizing iterative reconstruction method for reconstructing three-dimensional vesselness information from the vesselness filtered projections.

This may provide for a high quality vesselness prior.

According to another exemplary embodiment of the present invention, the iterative reconstruction is based on a term that maximizes an overlap of the reconstructed image and the vesselness prior, thereby favouring tubular objects.

In other words, the iterative reconstruction may be based on a regularisation favouring sparse objects, such as a L1-minimizing iterative reconstruction, a Gibbs smoothing prior (favouring smooth objects) and/or a term maximizing the overlap of the reconstructed image and the vesselness prior (thereby favouring tubular objects).

According to another exemplary embodiment of the present invention, the iterative reconstruction is performed on a volume which is larger than the desired final reconstruction volume followed by a cropping to the final reconstruction volume.

For example, after reconstruction a single image or an image sequence can be cropped or truncated to the final volume by removing areas of the reconstructed image which are outside the desired volume of interest.

According to another exemplary embodiment of the present invention, the iterative reconstruction of the object of interest is a three-dimensional iterative reconstruction.

Furthermore, according to another exemplary embodiment of the present invention, the object of interest is a coronary vessel-tree, wherein the examination apparatus is adapted for human coronary angiography.

According to another exemplary embodiment of the present invention, the examination apparatus is adapted as one of a three-dimensional rotational C-arm X-ray apparatus and a three-dimensional computed tomography apparatus.

Furthermore, according to another exemplary embodiment of the present invention, the examination apparatus is configured as one of the group consisting of a medical application apparatus and a material testing apparatus. One field of application of the invention is medical imaging.

According to another exemplary embodiment of the present invention, a method of examination of an object of interest with an examination apparatus is provided, in which projection data corresponding to projections of the object of interest are filtered, thereby reducing the projection background and ideally retaining only the object of interest, and in which an iterative reconstruction of the object of interest is performed on the basis of a regularisation which favours sparse objects.

This may provide for an improved image quality, especially in the case of coronary angiography.

According to another exemplary embodiment of the present invention, an image processing device for examination of an object of interest is provided, which comprises a memory for storing a series of projection images of the object of interest, wherein the series of projection images correspond to one cardiac phase. Furthermore, the image processing device comprises a calculation unit adapted for carrying out the above-mentioned method steps.

According to another exemplary embodiment of the present invention, a computer-readable medium is provided, in which a computer program of examination of an object of interest is stored which, when being executed by a processor, causes the processor to carry out the above-mentioned method steps.

Furthermore, according to another exemplary embodiment of the present invention, a program element for examination of an object of interest is provided, which, when executed by a processor, causes the processor to carry out the above-mentioned method steps.

Those skilled in the art will readily appreciate that the method of examination of the object of interest may be embodied as the computer program, i.e. by software, or may be embodied using one or more special electronic optimization circuits, i.e. in hardware, or the method may be embodied in hybrid form, i.e. by means of software components and hardware components.

The program element according to an exemplary embodiment of the invention may preferably be loaded into working memories of a data processor. The data processor may thus be equipped to carry out exemplary embodiments of the methods of the present invention. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

It may be seen as the gist of an exemplary embodiment of the present invention that a filtering of projections is performed in a pre-processing step, thereby reducing the background of the projections and on the other hand completely retaining the coronary arteries. After that, an iterative reconstruction is performed which favours sparse objects.

These and other aspects of the present invention will become apparent from and elucidated with reference to the embodiments described hereinafter.

Exemplary embodiments of the present invention will be described in the following, with reference to following drawings.

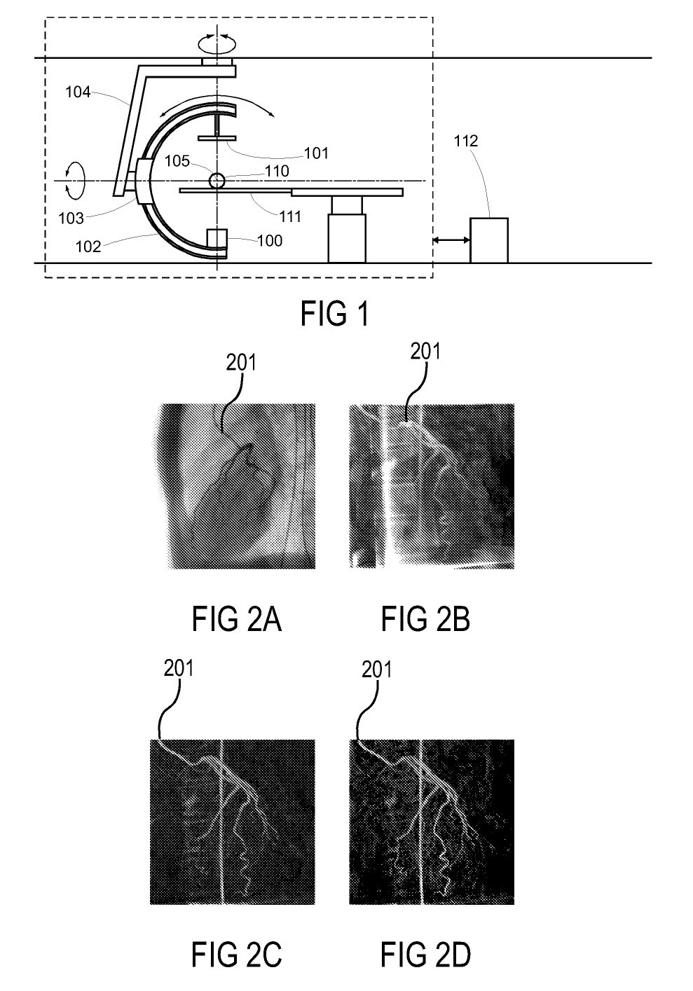

FIG. 1 shows a schematic representation of an exemplary rotational X-ray scanner according to an exemplary embodiment of the present invention.

FIG. 2A shows an X-ray angiography projection of a coronary artery.

FIG. 2B shows a reconstructed image reconstructed from the original projections.

FIG. 2C shows a reconstructed image, reconstructed from the original projections which have been top-hat filtered.

FIG. 2D shows a reconstructed image according to an exemplary embodiment of the present invention.

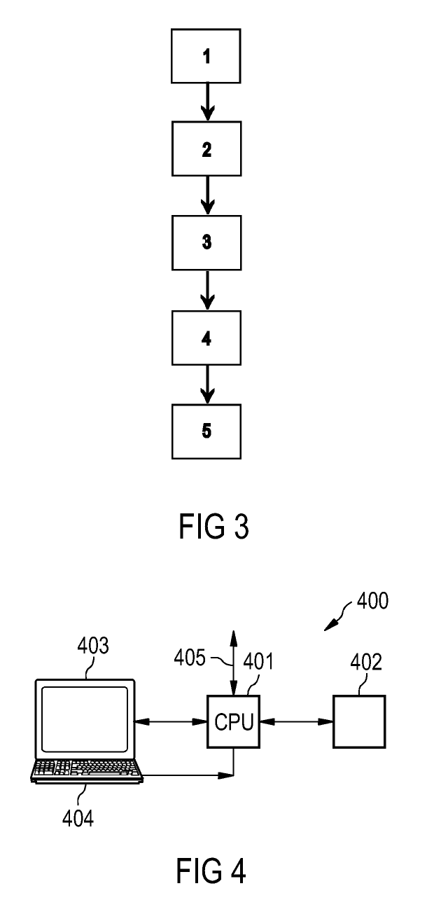

FIG. 3 shows a flow-chart of a method according to an exemplary embodiment of the present invention.

FIG. 4 shows an exemplary embodiment of an image processing device according to the present invention, for executing an exemplary embodiment of a method in accordance with the present invention.

The illustration in the drawings is schematically. In different drawings, similar or identical elements are provided with the same reference numerals.

FIG. 1 shows a schematic representation of an exemplary rotational X-ray scanner according to an exemplary embodiment of the present invention. An X-ray source 100 and a flat detector 101 with a large sensitive area are mounted to the ends of a C-arm 102. The C-arm 102 is held by curved rail, the “sleeve” 103. The C-arm can slide in the sleeve 103, thereby performing a “roll movement” about the axis of the C-arm. The sleeve 103 is attached to an L-arm 104 via a rotational joint and can perform a “propeller movement” about the axis of this joint. The L-arm 104 is attached to the ceiling via another rotational joint and can perform a rotation about the axis of this joint. The various rotational movements are effected by servo motors. The axes of the three rotational movements and the cone-beam axis always meet in a single fixed point, the “isocenter” 105 of the rotational X-ray scanner. There is a certain volume around the isocenter that is projected by all cone beams along the source trajectory. The shape and size of this “volume of projection” (VOP) depend on the shape and size of the detector and on the source trajectory. In FIG. 1, the ball 110 indicates the biggest isocentric ball that fits into the VOP. The object (e.g. a patient or an item of baggage) to be imaged is placed on the table 111 such that the object's volume of interest (VOI) fills the VOP. If the object is small enough, it will fit completely into the VOP; otherwise, not. The VOP therefore limits the size of the VOI.

The various rotational movements are controlled by a control unit 112. Each triple of C-arm angle, sleeve angle, and L-arm angle defines a position of the X-ray source. By varying these angles with time, the source can be made to move along a prescribed source trajectory. The detector at the other end of the C-arm makes a corresponding movement. The source trajectory will be confined to the surface of an isocentric sphere.

The C-arm x-ray scanner is adapted for performing an examination method according to the invention.

FIG. 2A shows an X-ray angiography projection of a coronary artery 201.

FIG. 2B shows a reconstructed image, reconstructed according to the method disclosed in [2] from the original projections.

FIG. 2C shows a reconstructed image, reconstructed as disclosed in [2], but from top-hat filtered projections.

FIG. 2D shows an image reconstructed according to an exemplary method of the present invention. Compared to FIG. 2C, the brightness and the contrast at the artery root may be similar, but the contrast for smaller vessels or vessel segments is increased.

It should be noted that the images depicted in FIGS. 2B, 2C and 2D are maximum intensity projections.

FIG. 3 shows a method according to an exemplary embodiment of the present invention. The method starts at step 1 with the acquisition of a rotational projection sequence of the selectively contrast agent enhanced coronary arteries.

Then, in step 2, the projections corresponding to one cardiac phase are selected from the rotational projection sequence, for example by nearest-neighbour ECG gating. However, other methods for selecting the projections may be used.

Then, in step 3, a pre-processing step is applied, in which the background of the projections is reduced by applying a morphological top-hat filter, which removes structures larger than a certain size. The coronary arteries are completely retained.

In step 4, a three-dimensional vesselness prior is calculated, which represents the probability of a point in the reconstruction volume to be occupied by a tubular structure. This is done by first applying a two-dimensional vesselness filter to the projection images and then using the L1-minimizing iterative reconstruction method to reconstruct three-dimensional vesselness information from the vesselness-filtered projections.

Then, in step 5, an iterative reconstruction method is used to reconstruct the three-dimensional image of the coronary arteries. As in [2], the minimization of the L1-norm and a Gibbs smoothing prior are used as regularisations. Additionally, a term that maximizes the overlap of the reconstructed and the vesselness prior is introduced into the reconstruction algorithm.

By doing so, the intensity in the reconstructed image may be concentrated onto areas that are likely to be occupied by the coronary arteries.

It should be noted that, as an option, the whole reconstruction process may be performed in a volume larger than the desired final reconstruction volume and the image may afterwards be cropped to the final volume. This may reduce background structures that form at the borders of the reconstruction volume.

The method according to the invention may produce reconstructions with higher contrast and detail, for example compared to gated reconstruction with standard filtered back-projection or to the method disclosed in [2].

FIG. 4 shows an exemplary embodiment of a data processing device 400 according to the present invention for executing an exemplary embodiment of a method in accordance with the present invention. The data processing device 400 depicted in FIG. 4 comprises a central processing unit (CPU) or image processor 401 connected to a memory 402 for storing an image depicting an object of interest, such as a patient or an item of baggage. The data processor 401 may be connected to a plurality of input/output network or diagnosis devices, such as a CT device. The data processor 401 may furthermore be connected to a display device 403, for example, a computer monitor, for displaying information or an image computed or adapted in the data processor 401. An operator or user may interact with the data processor 401 via a keyboard 404 and/or other output devices, which are not depicted in FIG. 4.

Furthermore, via the bus system 405, it may also be possible to connect the image processing and control processor 401 to, for example, a motion monitor, which monitors a motion of the object of interest. In case, for example, a lung of a patient is imaged, the motion sensor may be an exhalation sensor. In case the heart is imaged, the motion sensor may be an electrocardiogram.

Exemplary embodiments of the invention may be sold as a software option to CT scanner console, imaging workstations or PACS workstations.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. Examination apparatus for examination of an object of interest, the examination apparatus comprising a calculation unit adapted for:
filtering projection data corresponding to projections of the object of interest, resulting in a reduced background of the projections;
performing an iterative reconstruction of the object of interest on the basis of a regularisation which favours sparse objects.

2. Examination apparatus of claim 1,
wherein the filtering of the projection data comprises an application of a top-hat filter, which removes structures larger than a predetermined size.

3. Examination apparatus of claim 1,
wherein the iterative reconstruction is based on a L1-minimizing iterative reconstruction as regularisation.

4. Examination apparatus of claim 1,
wherein the iterative reconstruction is based on a Gibbs smoothing prior as regularisation, thereby favouring smooth objects.

5. Examination apparatus of claim 1,
wherein the calculation unit is further adapted for:
calculating a three-dimensional vesselness prior representing a probability of a point in a reconstruction volume of the projection data to be occupied by a tubular structure.

6. Examination apparatus of claim 5,
wherein the calculation of the three-dimensional vesselness prior is performed on the basis of an application of a two-dimensional vesselness filter to the projection images and then using a L1-minimizing iterative reconstruction method for reconstructing three-dimensional vesselness information from the vesselness filtered projections.

7. Examination apparatus of claim 5,
wherein the iterative reconstruction is based on a term that maximizes an overlap of the reconstructed image and the vesselness prior, thereby favouring tubular objects.

8. Examination apparatus of claim 1,
wherein the iterative reconstruction is performed on a volume which is larger than the desired final reconstruction volume followed by a cropping to the final reconstruction volume.

9. Examination apparatus of claim 1,
wherein the iterative reconstruction of the object of interest is a three-dimensional iterative reconstruction.

10. Examination apparatus of claim 1,
wherein the object of interest is a coronary vessel-tree; and
wherein the examination apparatus is adapted for human coronary angiography.

11. Examination apparatus of claim 1, being adapted as one of a three-dimensional computed tomography apparatus and a three-dimensional rotational C-arm X-ray apparatus.

12. Examination apparatus of claim 1, configured as one of the group consisting of a material testing apparatus and a medical application apparatus.

13. A method of examination of an object of interest with an examination apparatus, method comprising the steps of:
filtering projection data corresponding to projections of the object of interest, resulting in a reduced background of the projections;
performing an iterative reconstruction of the object of interest on the basis of a regularisation which favours sparse objects.

14. An image processing device, the image processing device comprising:
a memory for storing a series of projection images of the object of interest, the series of projection images corresponding to one cardiac phase;
a calculation unit adapted for:
filtering projection data corresponding to projections of the object of interest, resulting in a reduced background of the projections;
performing an iterative reconstruction of the object of interest on the basis of a regularisation which favours sparse objects.

15. A computer-readable medium (702), in which a computer program for examination of an object of interest is stored which, when executed by a processor (701), causes the processor to carry out the steps of:
filtering projection data corresponding to projections of the object of interest, resulting in a reduced background of the projections;
performing an iterative reconstruction of the object of interest on the basis of a regularisation which favours sparse objects.

16. A program element for examination of an object of interest, which, when being executed by a processor (701), causes the processor to carry out the steps of:
filtering projection data corresponding to projections of the object of interest, resulting in a reduced background of the projections;
performing an iterative reconstruction of the object of interest on the basis of a regularisation which favours sparse objects.
